(19) United States
(12) Patent Application Publication
(10) Pub. No.: US 2024/0137763 A1
(43) Pub. Date: Apr. 25, 2024

(54) CONTROL SYSTEM AND METHOD

(71) Applicant: JAGUAR LAND ROVER LIMITED, Whitley, Coventry, Warwickshire (GB)

(72) Inventor: Jitesh PATEL, Whitley, Coventry, Warwickshire (GB)

(21) Appl. No.: 18/547,110

(22) PCT Filed: Feb. 18, 2022
(86) PCT No.: PCT/EP2022/054087

§ 371 Date: Aug. 17, 2023

(30) Foreign Application Priority Data
Feb. 19, 2021 (GB) 2102329.6

(51) Int. Cl. H04W 12/06; H04W 12/61

(52) U.S. Cl. CPC H04W 12/06; H04W 12/61

(57) ABSTRACT

A control system is arranged to control, or provide input to a system to control, motion of a motor vehicle in response to a motion control signal received from a remote device, wherein the control system is configured to: transmit a verification request signal to the remote device; listen for a verification request reply signal transmitted from the remote device in response to the verification request signal transmitted; compare, in the event that a verification request reply signal is received from the remote device, the verification request reply signal to an expected verification request reply signal; and control, or provide input to a system to control motion of the vehicle in response to a motion control signal received from the remote device based on receipt of a verification request reply signal corresponding to the expected verification request reply signal.

### TECHNICAL FIELD

The present disclosure relates to a control system for a vehicle and to a method of controlling a vehicle and particularly, but not exclusively, to a control system for permitting remote control of vehicle movement. Aspects of the invention relate to a control system, a system, a vehicle, a method, a computer software program and a computer-readable storage medium.

### BACKGROUND

It is known to provide a vehicle park assist system for assisting a user in parking a vehicle. Some park assist systems are configured to provide an automatic parking function in which the vehicle park assist system is configured to control vehicle speed and steering autonomously in order to perform a parallel parking operation without a driver being required to provide any speed or directional control input to the vehicle. Some systems are configured to allow automatic perpendicular parking and garage parking. Some systems allow small adjustments to be made to vehicle position in which the vehicle is caused to move forward or backward by relatively small amounts, a feature known as ‘nudge’ movement.

The present applicant has recognised that it may be desirable to allow a driver to activate the automatic parking function remotely, by means of a remote device such as a smartphone, smartwatch or other device such as a key fob with a touchscreen, the remote device running a suitable software application (which may be referred to as an ‘app’ or ‘widget’). It may also be desirable to permit a driver to control vehicle movement separately by controlling direction of travel, speed and steering angle by means of the same or a similar device. This function may be particularly useful in off-road situations in which a vehicle is required to navigate challenging terrain.

The present applicant has also recognised that it is important to ensure reliability of systems for controlling vehicle movement, particularly if operated remotely.

The present inventors have recognised that a communications failure between the smartphone and park assist control system could cause control of the vehicle to become unreliable. It is an aim of the present invention to ameliorate this problem.

### SUMMARY OF THE INVENTION

Aspects and embodiments of the invention provide a control system, a remote device and a method of controlling motion of a vehicle as claimed in the appended claims.

According to an aspect of the present invention there is provided a control system comprising one or more controllers, the control system arranged to control, or provide input to a system to control, motion of a motor vehicle in response to a motion control signal received from a remote device, wherein the control system is arranged to perform a repeating verification cycle in which the control system is configured to: transmit a verification request signal to the remote device; listen for a verification request reply signal transmitted from the remote device in response to the verification request signal transmitted; compare, in the event that a verification request reply signal is received from the remote device, information comprised by the verification request reply signal to an expected verification request reply information; and control, or provide input to a system to control motion of the vehicle in response to a motion control signal received from the remote device in dependence on the comparison.

Embodiments of the present invention have the advantage that, in the event that a communication link between the remote device and the control system fails, for example due to malfunctioning of the remote device or corruption of data communicated, the control system may be prevented from controlling, or providing input to a system to control, motion of the motor vehicle in response to signals received from the remote device.

Optionally, the one or more controllers collectively comprise: at least one electronic processor having an electrical input for receiving the verification request reply signal and an electrical output for transmitting the verification request signal; and at least one memory device coupled to the at least one electronic processor and having instructions stored therein; wherein the at least one electronic processor is configured to access the at least one memory device and execute the instructions stored therein so as to control, or provide input to a system to control, motion of the motor vehicle.

Optionally, the expected verification request reply information comprises information indicative of a result of a predetermined operation.

Optionally, the verification request signal comprises argument information to be used within an operation, and the expected verification request reply information comprises information indicative of a result of said operation using the argument information.

Optionally, successive verification request signals transmitted by the control system each comprise information that includes argument information generated by the system, being information indicative of one or more arguments to be used with an operation, the system being configured to determine expected operation result information being information indicative of a result of a predefined operation using the argument information, the system being further configured to determine whether information comprised by the verification request reply signal received from the remote device includes operation result information corresponding to the expected result determined by the control system, wherein the system is configured to control, or provide input to a system to control motion of the vehicle in response to a motion control signal received from the remote device in dependence on a correspondence between the received operation result information and expected operation result information. It is to be understood that, in order to determine a correspondence between transmitted argument information and the received operation result information, the control system may associate a respective identifier with each successive verification request signal and transmit information indicative of the identifier with the argument information in the verification request signal. The remote device may, in turn, associate the same identifier or index with the corresponding result of the predefined operation performed by the remote device and transmit information indicative of the identifier with the corresponding operation result information in the verification request reply signal.

Optionally, the system is configured to store the expected operation result information together with the argument information and identifier information associated with the argument information and operation result information in a memory associated with the control system, the system being configured to include, in the verification request signal, the identifier information associated with the argument information comprised by the verification request signal, wherein the system being configured to determine whether information comprised by the verification request reply signal received from the remote device includes operation result information corresponding to the expected operation result determined by the control system comprises the system being configured to compare received result information and stored expected result information having common identifier information.

Thus, it is to be understood that the received verification request reply signal includes both information indicative of the result of the predefined operation and information indicative of the identifier associated with the argument information for the predefined operation, allowing comparison of received and expected operation result information.

Optionally, once a verification request reply signal has been received having identifier information therein and the system has compared received result information and stored expected result information associated with that identifier information, the system is configured not to compare further received expected result information associated with that identifier information until fresh expected result information has been stored with the same identifier information.

This feature has the advantage that a replay attack in which a verification request reply signal transmitted by the remote device is replayed by a third party in order to cause the system to continue responding to motion control signals received from the same or a further remote device may be prevented.

Optionally, the system is configured wherein once a verification request reply signal has been received having identifier information therein and the system has compared received result information and corresponding stored expected result information associated with that identifier information, the system is configured to delete the stored expected result information and corresponding identifier information from memory.

It is to be understood that the consequence of deletion of the stored expected result information and corresponding identifier information from memory has the effect that, if the system receives fresh expected result information associated with the same identifier information the system will be unable to compare the received result information with stored expected result information until fresh expected result information has been stored having corresponding identifier information.

Optionally, the system is configured to prevent motion of the vehicle in response to a motion control signal received from the remote device in dependence on a number of times a verification request reply signal is received by the system within a prescribed time period that does not correspond to the expected verification request reply signal.

Thus, it is to be understood that, in some embodiments, if no verification request reply signals are received in response to the transmission of verification request signals over a given time period the system may prevent motion of the vehicle in response to motion control signals received from the remote device.

In some embodiments, if a verification request reply signal is received containing operation result information that does not correspond to the expected operation result information more than a predetermined number of times within the prescribed time period, the system may prevent motion of the vehicle in response to motion control signals received from the remote device. It is to be understood that the system may determine whether the operation result information corresponds to expected operation result information based on identifier information contained in the verification request reply signal received.

Optionally, the system is configured to prevent motion of the vehicle in response to a motion control signal received from the remote device in dependence on whether the order in which successive verification request reply signals are received corresponds to the order in which corresponding successive verification request signals were transmitted.

Optionally, the system is configured to prevent motion of the vehicle in response to a motion control signal received from the remote device in dependence on a number of times within a given time period the order in which successive verification request reply signals are received does not correspond to the order in which corresponding successive verification request signals were transmitted.

Optionally, the system is configured to implement a cyclic redundancy check (CRC) in respect of data received.

According to a further aspect of the invention there is provided a method of controlling motion of a vehicle by means of a control system, the method comprising controlling, or providing input to a system to control, motion of a motor vehicle in response to a motion control signal received from a remote device, the method comprising performing a repeating verification cycle, the method comprising: transmitting a verification request signal to the remote device; listening for a verification request reply signal transmitted from the remote device in response to the verification request signal transmitted; comparing, in the event that a verification request reply signal is received from the remote device, information comprised by the verification request reply signal with expected verification request reply information; and controlling, or providing input to a system to control motion of the vehicle in response to a motion control signal received from the remote device in dependence on the comparison.

The method may comprise preventing vehicle movement responsive to a motion control signal received from the remote computing device in dependence on receipt of the expected verification request reply signal.

In an aspect of the invention there is provided a remote device configured to communicate with a control system arranged to control, or provide input to a system to control, motion of a motor vehicle in response to a motion control signal received from the remote device, wherein the remote device is configured to: listen for a verification request signal transmitted by the control system; in response to receipt of a verification request signal transmitted by the control system, transmit a verification request reply signal to the control system.

Optionally, the remote device is configured, in response to receipt of a verification request signal, to perform a predefined operation using argument information contained in the verification request signal, the device being configured to transmit the verification request reply signal in response to performing the predefined operation, the verification request reply signal comprising information indicative of the result of the predefined operation together with identifier information contained in the verification request signal.

In a still further aspect of the invention there is provided a method of controlling motion of a vehicle having a control system, the method comprising, by means of a remote device, communicating with a control system arranged to control, or provide input to a system to control, motion of a motor vehicle in response to a motion control signal received from the remote device, the method comprising: listening for a verification request signal transmitted by the control system to the remote device; in response to receipt of a verification request signal transmitted by the control system, transmitting a verification request reply signal to the control system.

Optionally, the method comprises, at the remote device, in response to receipt of a verification request signal by the remote device, performing a predefined operation using argument information contained in the verification request signal, the method comprising transmitting the verification request reply signal from the remote device to the control system in response to performing the predefined operation, the verification request reply signal comprising information indicative of the result of the predefined operation and identifier information contained in the verification request signal.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a schematic illustration of (a) a vehicle according to an embodiment of the present invention having an onboard environment perception and trajectory planning system in the form of a near field sensing system (NFS) in the present embodiment that may be controlled by a remote device in the form of a smartphone, and (b) a centre console of the vehicle;

FIG. 2 is a schematic illustration of the manner in which the remote device communicates with the NFS;

FIG. 3 is a schematic illustration of the manner in which further vehicle components communicate with one another;

FIG. 4 illustrates operation of the NFS and remote device 1900 in further detail;

FIG. 5 illustrates the accumulation in non-volatile memory (NVM) of values of index, local time information and operation result information;

FIG. 6 is a flow diagram illustrating operation of the NFS;

FIG. 7 is a flow diagram illustrating operation of the remote device;

FIG. 8 illustrates the contents of the NVM before (block T1) and after (block T1′) receipt of a first verification request reply signal from the remote device;

FIG. 9 is a flow diagram illustrating operation of the NFS when receiving a verification request reply signal from the remote device;

FIG. 10 illustrates a correspondence between the verification request signal and the verification request reply signal in the method of the embodiment of FIGS. 1 to 9;

FIG. 11 is a simplified illustration of a control system such as may be adapted in accordance with an embodiment of the present invention; and

FIG. 12 illustrates a vehicle travelling along a path having a row of smart pillars along a side of the desired path in order to guide a path of travel of the vehicle.

### DETAILED DESCRIPTION

A control system, system, vehicle and method in accordance with an embodiment of the present invention is described herein with reference to the accompanying Figures.

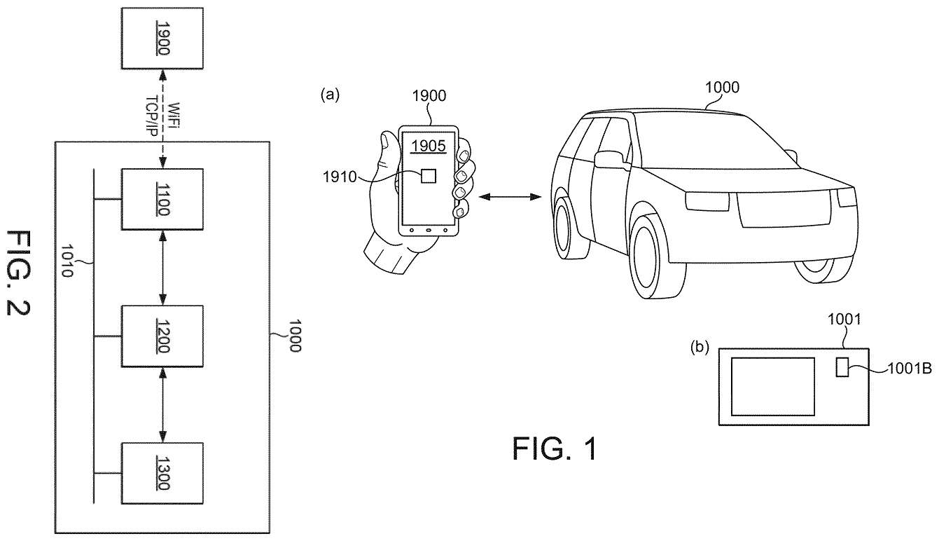

FIG. 1(a) is a schematic illustration of a vehicle 1000 according to an embodiment of the present invention. The vehicle 1000 is arranged to communicate with a suitably configured remote device 1900 and to allow the remote device 1900 to control a park assist function of the vehicle 1000 whereby the vehicle 1000 may be caused, by means of the remote device 1900, to manoeuvre, at low speed. They system may be employed to manoeuvre a vehicle at low speed into a parking space. In some scenarios the system may be employed to manoeuvre a vehicle over challenging terrain such as challenging off-road terrain.

The remote device 1900 and vehicle 1000 are also configured to allow the remote device 1900 to control a remote control drive functionality whereby the user can use the remote device 1900 to control freely the vehicle's longitudinal and lateral motion, not being limited to activating a park assist function in which the vehicle 1000 executes autonomously a parking manoeuvre, although in some embodiments the remote device 1900 may be configured to allow a user to activate the park assist function and not allow the user to control motion of the vehicle freely.

It is to be understood that in the present embodiment the vehicle speed is limited to 2 kph when the vehicle is executing the park assist function and 8 kph when remote control drive functionality is implemented. It is to be understood that, in some embodiments, other values of maximum speed may be employed for operation in one or both of these functions. For example, in some embodiments, vehicle speed may be limited to 10 kph when under the control of a remote device. In some alternative embodiments, vehicle speed may be limited to kph when under the control of a remote device.

In the embodiment illustrated the remote device 1900 is a user's smartphone.

However, it is to be understood that in some embodiments the remote device may be associated with a substantially fixed installation such as a parking facility, vehicle charging facility or other facility. The control signals may be generated by the remote device in order to guide the vehicle 1000 to park at a location appropriate for the vehicle at the facility, such as at a location at which a battery of the vehicle 1000 may be charged. In some embodiments the remove device 1900 may be a smartwatch with HMI interface including buttons and/or a touch screen enabling a user to interact with the vehicle 1000 remotely.

FIG. 2 is a schematic illustration of the manner in which the remote device 1900 communicates with the vehicle 1000. The vehicle 1000 has a telematics control unit (TCU) 1100 (which may also be described as a vehicle domain controller (VDC)), a gateway module (GWM) 1200 and a near-field sensing system (NFS) 1300. The TCU 1100 provides an interface between the remote device 1900 and a vehicle controller area network (CAN) bus 1010 to which the GWM 1200 and NFS 1300 are also connected. In the present embodiment, the CAN bus 1010 employs ethernet networking technology (IEEE 802.3) to facilitate communications between connected systems. However, it is to be understood that the present invention is not limited to ethernet technology and any suitable networking technology may be employed. It is to be understood that, in some embodiments, the remote device 1900 may communicate directly with the NFS 1300 rather than via the GWM 1200.

The remote device 1900 is configured to establish a wireless communications link or ‘connection’ between the remote device and TCU 1100 by means of a short-range wireless communications protocol. In the present embodiment the remote device 1900 is configured to establish a wireless communications link using a ‘wi-fi’ protocol, however other protocols may be used in addition or instead such as Bluetooth (RTM). As noted above is to be understood that the remote device 1900 may be any suitable device such as a smartphone, smartwatch, a tablet computer or any other suitable programmed computing device. The remote device 1900 has a remote vehicle control (RVC) software program or application installed. When the RVC app is running, the program enables a user of the remote device 1900 to control movement of the vehicle using the remote device 1900. In the present embodiment, the RVC program permits the user to activate a park assist (PA) function of the vehicle remotely. The PA function is implemented by the NFS 1300. The NFS 1300 is provided with remote park assist (RPA) functionality, permitting the NFS 1300 to receive commands in respect of the PA function from the remote device 1900. In the present embodiment, the PA function may be activated by a user when driving the vehicle 1000 by means of a PA function activation button 1001B provide on a centre console 1001 of the vehicle 1000 (FIG. 1(b)). When the PA function is activated, the NFS 1300 is configured automatically to execute a parallel parking manoeuvre in which the vehicle NFS 1300 identifies a suitable parking space as the vehicle travels along a road, and then determines a desired path of travel for the vehicle 1000 in order to park the vehicle in that space. That is, the NFS 1300 controls a speed and steering angle of the vehicle 1000 in order to parallel park the vehicle 1000. The NFS 1300 determines the proximity of other objects to the vehicle 100 by means of sensors comprised by the vehicle 1000. It is to be understood that other parking manoeuvres may be performed in some embodiments in addition or instead, such as perpendicular parking, garage parking (whereby a vehicle is caused to move into a garage), or nudge parking (in which a vehicle is caused to move incrementally forward or backward in order to position the vehicle correctly at a desired location).

By pressing a button 1910 on the remote device 1900, the RPA function may be activated. In the illustrated embodiment the remote device 1900 is a smartphone having a touchscreen 1903. The button 1910 is provided in the form of an icon displayed on the touchscreen 1903. In some alternative embodiments the remote device may be provided with a physical button instead. In some embodiments, the remote device 1900 may be configured to detect dynamic gestures by means of the touchscreen, such as swiping, for example sliding a user's finger in a particular direction. In some embodiments a slide and hold gesture may be required to be performed in order to avoid accidental activation of a feature. For example, a user may be required to touch a particular location on a touchscreen and slide their finger in a particular direction to a given location and then hold their finger in that location in order to activate a feature, such as causing forward or reverse movement of the vehicle, optionally forward or reverse movement in a particular direction. In some embodiments a direction of steer of the vehicle may be controlled based on a direction in which a user slides their finger.

Other arrangements may be useful in some embodiments.

As shown in FIG. 2, in the present embodiment, when the vehicle 1000 receives a signal from the remote device 1900 it is configured to communicate information received from the remote device 1900 to the GWM 1200 via the CAN bus 1010. The GWM 1200 in turn communicates the received information to the NFS 1300 via the CAN bus 1010. In the present embodiment, the User Datagram Protocol (UDP) communications protocol is employed for communications between the TCU 100 and the GWM 1200, and between the GWM 1200 and the NFS 1300. It is to be understood that any suitable automotive communications protocol may be employed over the wired network instead of or in addition to a CAN bus, such as FlexRay, Ethernet, Local Interconnect Network (LIN) or any other suitable protocol.

It is to be understood that, in the present embodiment, communication between the remote device 1900 and vehicle 1000 employs a cyclic redundancy check (CRC) methodology to detect communication errors. However, embodiments of the present invention implement a more sophisticated communications integrity verification methodology that is more appropriate to the control of vehicle movement by means of a consumer grade computing device such as a smartphone, the integrity and correct operation of which a manufacturer of the vehicle 1000 may have little or no control. Thus, the NFS 1300 is configured to verify the correct operation of the remote device 1900 in order to ensure correct control of movement of the vehicle 1000. The verification of the correct operation of the remote device by the NFS 1300 may be referred to as a verification cycle.

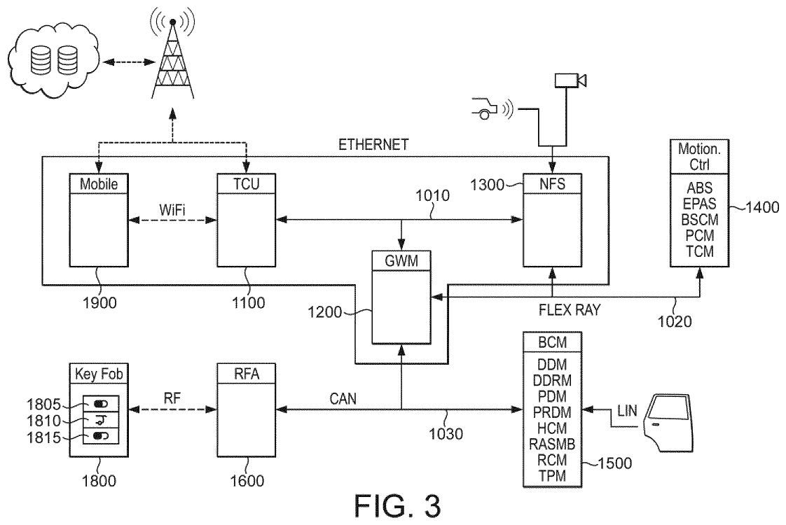

FIG. 3 illustrates the manner in which further vehicle components communicate with one another in the present embodiment. As shown in FIG. 3, the NFS 1300 is also in communication with the GWM 1200 and in addition a motion control unit (MCU) 1400 via a separate motion control communications bus 1020. The motion control communications bus 1020 permits independent communication between each of the GWM 1200, NFS 1300 and MCU 1400.

The motion control unit 1400 is configured to communicate with a vehicle anti-lock braking system (ABS), electronic park assist system (EPAS), Brake System Control Module (BSCM), powertrain control module (PCM) and Transmission Control Module (TCM).

The GWM 1200 is also in communication with a remote fob module (RFA) 1600 and a body control module (BCM) 1500 by means of a BCM communications bus 1030. The RFA 1600 is configured to communicate with a remote key fob 1800 carried by a user. The remote fob 1800 is provided with a wireless radio frequency communications capability. The RFA 1600 is configured periodically to attempt to communicate wirelessly with the remote fob 1800 in order to determine whether the remote fob 1800 is within range of communication with the RFA 1600. If the RFA 1600 determines that the remote fob 1800 is within range of communication with the RFA 1600, the RFA 1600 informs the GWM 1200 via the BCM communications bus 1030 such that the GWM 1200 is aware, at a given moment in time, whether the remote fob 1800 is within range of communication with the RFA 1600. It is to be understood that the GWM 1200 is configured to prevent certain vehicle functions from being activated, such as movement of the vehicle (by preventing powertrain operation) and a vehicle infotainment system unless the remote fob 1800 is within range of communication with the RFA 1600. Thus, the motion control unit 1400 is configured to require an indication from the GWM 1200 that powertrain operation is allowed before it can allow powertrain operation.

The remote fob 1800 is provided with three user-operable controls—a master lock control button 1805, a boot (or ‘trunk’) unlock button 1810 and a master unlock button 1815. In response to pressing of one of the buttons 1805, 1810, 1815 the remote fob 1800 transmits a radio signal to the RFA 1600 indicative of the identity of the button pressed. The RFA 1600 in turn transmits a signal to the BCM 1500 indicative of the identity of the button pressed. If the user has pressed the master lock button 1805, the BCM 1500 causes all door locks and a boot lock of the vehicle 100 to lock. If the user has pressed the boot unlock button 1810, the BCM 1500 causes a boot lock only of the vehicle 100 to open. If the user has pressed the master unlock button 1815, the BCM 1500 causes all door locks and a boot lock of the vehicle 100 to open.

As shown in FIG. 2, the NFS 1300 is configured to communicate with the remote device 1900 via the GWM 1200 and TCU 1100. It is to be understood that embodiments of the present invention are configured periodically to check that a communications link between the remote device 1900 and NFS 1300 is functioning correctly, and furthermore that the remote device 1900 is functioning correctly. In order to accomplish this, the NFS 1300 is configured to transmit, repeatedly, a verification request signal to the remote device 1900 via the GWM 1200 and TCU 1100 and to listen for a verification request reply signal transmitted by the remote device 1900 back to the NFS 1300 via the TCU 110 and GWM 1200 in response to receipt of the verification request signal. It is to be understood that, in the present embodiment, the verification request signals and verification request reply signals are in addition to signals transmitted between the remote device 1900 and NFS 1300 for controlling the vehicle 100.

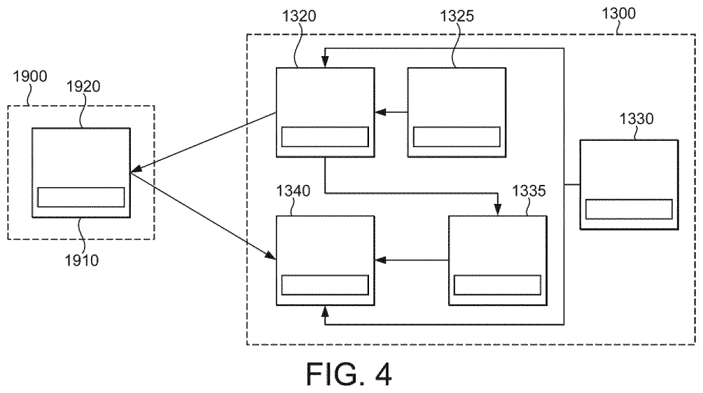

FIG. 4 illustrates operation of the NFS 1300 and remote device 1900 in further detail. The NFS 1300 is configured to provide, in computer program code, a challenge generator function 1320, a random number generator function 1325 and a response validator function 1340. The random number generator function 1325 generates three successive random numbers (or pseudo-random numbers) and provides the generated numbers to the challenge generator function 1320. The challenge generator function 1320 performs a predefined operation (which may, for example, comprise one or more calculations such as division or multiplication) using the provided numbers as the arguments (argument information) and stores a result of the predefined operation in a non-volatile memory (NVM) 1335 of the NFS 1300. This result may be referred to as ‘operation result information’. It is to be understood that other types of memory may be used in addition or instead, such as volatile memory (VM). VM may have the advantage that it may be written to and/or read from at a faster speed than NVM in some embodiments. In the present embodiment, the three random numbers form three arguments (Part 1, Part 2 and Part 3), i.e. the argument information for an operation performed by the challenge generator function 1320. In the present embodiment, the parts are 8-bit unsigned. This has the advantage that the operation may be performed on any computing device having an 8-bit architecture or higher. In the present embodiment, the operation may be written as follows:

Response=(((Part1*Part2)>>(Part3&&0x0F)+(Part3∧Part1)<<(Part2−Part1))/(0x03))

where the parameter ‘Response’ is the result of the operation, and therefore the response to be expected from the remote device 1900 when it performs the same operation, ‘>>’ refers to a right bit shift operation, ‘<<’ refers to a left bit shift operation and ‘∧’ is an exclusive OR (XOR) operation. It is to be understood that the above operation utilises a number of different operations that a central processing unit (CPU) of the remote device 1900 is to be expected to perform reliably. Furthermore, the operation is arranged to avoid generation of overflows. Thus, following the multiplication operation, in which Part 1 and Part 2 are multiplied together, the result is right shifted so the data returns to the 8-bit range. It is to be understood that ‘0x03’ is shorthand for ‘000003’ which represents the quantity ‘3’. The final step of division by 3 is intended to avoid division by a very large number which can result in a very low numerical result, which may show as a ‘000000’ result. Such a result would not meet the criteria for the result to be considered valid.

It is to be understood that by using unsigned bits in the operation, a negative number cannot be generated as a result of an operation. This feature increases the compatibility of the operation with a range of different computer system architectures, some of which may not support negative numbers.

It is to be understood that the operation defined by the equation above will result in a deterministic output that is independent of the programming language and compilers used, and therefore provides more flexibility for remote device development. More generally, equations that satisfy the following conditions are advantageous:
(1) It does not rely on signed arithmetic and representation of signed numbers;
(2) It protects against division by zero; and
(3) it utilizes all basic operation of generic central processing units (arithmetic, logical, bitwise) to give more confidence in respect of the operating condition of the remote device, which may employ consumer grade electronics as opposed to the higher-grade electronics employed in motor vehicle onboard control systems.

A local timer function 1330 provided by the NFS 1300 provides local time information to the challenge generator 1320. When storing the result of an operation (the expected ‘Response’) using the argument information generated by the random number generator function 1325, the challenge generator 1320 also stores the local time information provided by the local timer function 1330 when the result of the operation is stored in the NVM 1335. In the present embodiment, the NFS 1300 is also configured to store an index value together with each stored value of (a) operation result (‘Expected Response’) and (b) corresponding local time information. In the present embodiment, the index value is incremented by a predetermined amount for each successive operation result. It is to be understood that this local time stamp will be used later to detect communication problems (slow response, no response). The local time stamp is employed in order to avoid a requirement to employ common clock/time information between the remote device 1900 and the onboard electronic control unit (ECU) of the NFS 1300. This reduces the amount of network data exchange and eliminates the problem of synchronizing the clocks between the remote device 1900 and NFS 1300. It is to be understood that the index may be used to detect sequencing errors and helps in accessing stored data more quickly as described below.

Once the result of the predefined operation has been generated, the NFS 1300 is configured to transmit to the remote device 1900 the verification request signal which includes (a) the index value and (b) the argument information to be used for the operation (Part 1, Part 2 and Part 3). In some embodiments the index value may be omitted and the local time information used as an index or identifier of the argument information transmitted.

It is to be understood that an advantageous feature of the present embodiment is that local time is not required to be, and is not, transmitted to the remote device 1900 from the NFS 1300. The NFS 1300, acting as challenger, manages time itself and does not require synchronisation with the remote device 1900. This feature helps the NFS 1300 to compensate for internal clock jitters and different ways of storing local time stamp information, avoiding the need for synchronization of time between two devices (in this case, the NFS 1300 and remote device 1900).

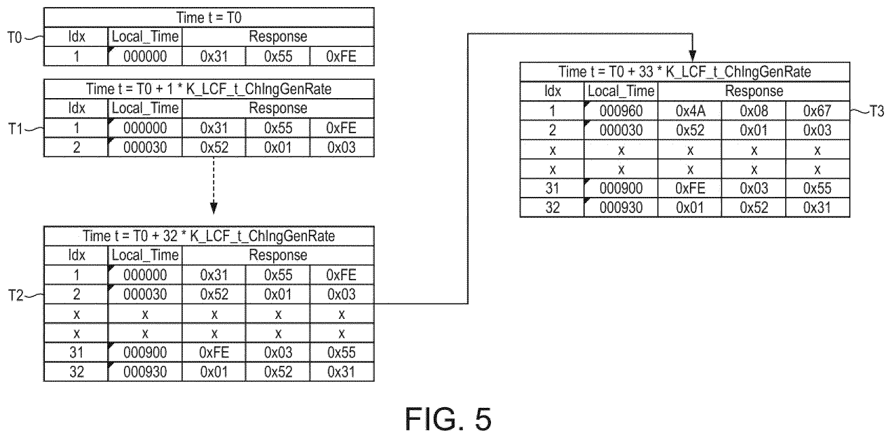

FIG. 5 illustrates the accumulation in the NVM 1335 of stored values of index, local time information and operation result information. Block TO is a schematic illustration of the content of the NVM 1335 at time t=TO. As shown, the NVM 1335 has stored therein data associated with a single index value. The stored data is in the form of the index value (Idx) which in this example is ‘1’, a local time value which in this example is ‘000000’, and operation result information in the form of three stored values, which in this example are ‘0x31’ (an abbreviation of ‘000031’), ‘0x55’ and ‘0×FE’.

Block T1 shows the content of the NVM 1335 at time t=T1, once data corresponding to each of two index values have been stored. As can be seen from the data, the time lapse between operations using successive argument information was 30 ms. Other values of time lapse may be useful in some embodiments.

Block T2 shows the content of the NVM 1335 at time t=T2, once 32 index values with corresponding local time and operation result information has been stored. As can be seen from block T3, which illustrates the content of the NVM 1335 at a time t=T3 of 30 ms after time T2, the subsequent index value after the 32^{nd} index value reverts to ‘1’ and the local time data and operation result information overwrites the previous such data corresponding to the same index value. Thus, the NFS 1300 implements a circular buffer methodology in respect of the storing of data in the NVM 1335. It is to be understood that employing a circular buffer helps to reduce the memory usage and automatically purges old stored values by overwriting with new values more frequently. This makes the algorithm faster and the system will discard responses which come after too much time has elapsed (relatively old messages). This reduces the risk of a replay attack (or playback attack) on the system. By replay attack is meant a situation in which data transmitted by the remote device 1900 to control the vehicle 1000 is fraudulently repeated or delayed by a third party.

It is to be understood that other values of number of index values may be stored before rollover occurs, depending on the actual protocols, electrical architecture and system need. The larger the value, the more memory required to implement the method. However, too small a value will result in more frequent rollover and may cause the system to be overly sensitive to electrical and/or electromagnetic noise.

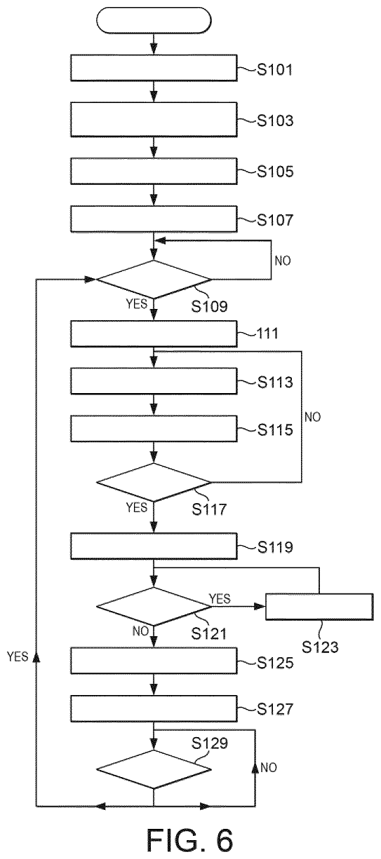

FIG. 6 is a flow diagram illustrating the operation of the NFS 1300, acting as challenger, in further detail.

At step S101 the NFS 1300 initializes the local timer function 1330 by setting an initial value of time information associated with the local timer function 1330 to a predetermined base timer value (such as zero). It is to be understood that initialization may also be referred to as ‘resetting’ the timer function 1330. The local timer function 1330 begins timing from the base timer value.

At step S103 the random number generator function 1325 is also initialized (or ‘reset’). It is to be understood that the random number generator function may be provided in the form of a hardware-based true random number generator or a software-based pseudo-random number generator requiring a “seed” value to initialize the software. The initialization or reset of the random number generator function generally happens after a saturation period (where the random numbers start repeating) or at each power cycle. In the present embodiment the random number generator function 1325 is implemented in software.

At step S105, ‘old’ data stored in the NVM 1335 is cleared. In some embodiments this is performed by setting all stored values to a predetermined value, such as zero. Thus, in the present embodiment, stored values corresponding to (a) index values, (b) values of the results of operations and (c) local time information associated with the operations are set to a predetermined value such as ‘0’.

At step S109 the NFS 1300 checks whether a remote device 1900 has established a communications connection with the TCU 1100. If the remote device 1900 has not established a connection, the NFS 1300 repeats step S109. That is, the NFS 1300 does not generate any challenges by means of the challenge generator 1320 until a remote device 1900 successfully connects to the vehicle 1000. If the remote device 1900 has established a connection, then at step 111 the NFS 1300 starts a periodic timer function by storing a periodic timer start value, being the current value of time information being output by the local timer function 1330, in a memory of the NFS 1300. In the present embodiment, the periodic timer start value is stored in the NVM 1335. Other ways of implementing a periodic timer function may be useful in some embodiments.

At step S113 the challenge generator 1320 receives three new random or pseudo-random numbers from the random number generator function 1325. At step S115 the challenge generator 1320 performs the predefined operation described above using the received numbers (Part 1, Part 2 and Part 3) as the arguments. At step S117 the challenge generator 1320 determines whether the result of the operation meets certain predefined criteria in order to be considered valid. If the result does not meet the criteria, it is considered invalid and the method continues at step S113. If the result does meet the criteria it is considered valid and the method continues at step S119.

In the present embodiment, in order for the result of the operation to be considered valid, the memory data bits representing the result must not all be logical ‘1’ or all logical ‘0’. It is to be understood that one or more other criteria or conditions may be useful in addition or instead. The feature that the challenge generator 1320 performs the predefined operation has the advantage that the challenge generator 1320 is able to verify that the result of the challenge meets the predefined criteria before the challenge is transmitted to the remote device 1900. It is to be understood that if a result of the predefined operation is that all the memory bits are logical ‘1’ or logical ‘0’, the NFS 1300 may not be able to distinguish this from a corrupted response from the remote device 1900 in which all the bits are set to logical ‘1’ or ‘0’. Furthermore, by performing the operation and storing the result in the NVM 1335 at this stage, rather than storing the argument information (in the present embodiment the three arguments) only, the NFS 1300 is able more quickly to determine whether the result of the operation performed by the remote device 1900 corresponds to the ‘correct’ response, because the NFS 1300 does not have to perform the operation using stored argument information after the verification request reply signal has been received.

At step S119, the index value is incremented by a predetermined amount, in the present embodiment by ‘1’.

At step S121 the NFS 1300 determines whether a predetermined maximum value of index has been reached, in the present embodiment a value of ‘32’. If the maximum value has been reached then at step S123 the index value is reset to a predetermined index baseline value, in the present embodiment a value of ‘1’. If the maximum value has not been reached then the method continues at step S125. It is to be understood that this implementation of circular buffer technology allows the software to use static arrays which can be helpful in proving deterministic behaviour in the context of functional safety and compliance with required standards such as the International Standards Organisation (ISO) 26262 functional safety standard and the Motor Industry Software Reliability Association (MISRA) standard.

At step S125 the NFS 1300 stores the current value of index, the current value of time output by the timer function 1325 and the result of the operation using the generated arguments in the NVM 1335.

At step S127 the NFS 1300 transmits to the remote device 1900 the arguments generated at step S113 together with the value of index stored in the NVM at step S125.

At step S129 the NFS 1300 determines an amount of time that has elapsed since the most recent value of periodic timer start value was stored. It does this by comparing the current value of time information output by the local timer function 1330 with the stored periodic timer start value. If the difference between the values exceeds a predetermined amount, the NFS 1300 determines that the periodic timer function has expired and the method continues at step S109 else step S129 is repeated. In the present embodiment, the method is configured such that the NFS 1300 waits until a time period of at least 30 ms has elapsed since the most recent value of periodic timer start value was stored before continuing at step S109. Thus, the NFS 1300 is configured such that a period of at least 30 ms elapses between the transmission of successive verification request signals.

It is to be understood that, by sending the challenges periodically, embodiments of the present invention can detect a failure in the form of a loss of communication irrespective of the communications protocol employed (whether Wi-Fi, Bluetooth or other).

Upon receipt of a verification request signal from the NFS 1300 (via the GWM 1200 and TCU 1100), the remote device 1900 provides the received index value, time information and argument information to a response generator function 1920 (FIG. 4) that is implemented in computer program code by the remote device 1900. The response generator function 1920 is configured to perform the same predefined operation using the received argument information as that performed by the challenge generator function 1320 of the NFS 1300. The remote device 1900 then transmits the verification request reply signal back to the NFS 1300 via the TCU 110 and GWM 1200, the verification request reply signal including the result of the predefined operation using the received argument information and the corresponding index value and local time information received by the remote device 1900 from the NFS 1300.

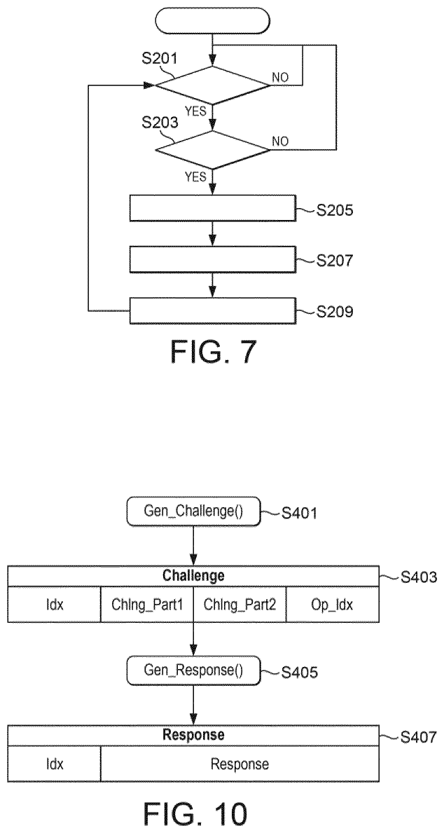

FIG. 7 illustrates in further detail the operation of the remote device 1900.

At step S201 the remote device 1900 checks whether it has established a communication link with the TCU 1100 of the vehicle 100. If a link has been established the method continues at step S203 else the method repeats step S201.

At step S203 the remote device 1900 checks whether a verification request signal has been received from the NFS 1300 of the vehicle 100. If such a signal has been received the method continues at step S205 else the NFS 1300 continues at step S201.

At step S205 the response generator function 1920 performs the predefined operation using the received argument information, the predefined operation corresponding to that performed by the challenge generator function 1320 of the NFS 1300.

At step S207 the remote device 1900 combines the result of the predefined operation with the index value and time information received from the NFS 1300 by means of the verification request signal.

At step S209 the remote device 1900 transmits the result of the predefined operation with the received index value in the form of a verification request reply signal to the NFS 1300. The method then continues at step S201.

Upon receipt of a verification request reply signal, the NFS 1300 is configured to check whether the verification request reply signal corresponds to an expected verification request reply signal by determining whether it contains expected verification request reply information. The NFS 1300 determines whether the verification request reply signal contains expected verification request reply information by determining whether the value of the result of the predefined operation performed by the remote device 1900 corresponds to the expected value stored by the NFS 1300 in the NVM 1335, i.e. whether the value of the result of the predefined operation performed by the remote device 1900 corresponds to expected operation result information being the operation result information stored by the NFS 1300 in the NVM 1335.

As shown in FIG. 4, the NFS 1300 has a response validator 1340 that receives the verification request reply signal from the remote device 1900. The response validator 1340 retrieves from the NVM 1300 the previously stored value of the result of the predefined operation corresponding to the same index value as that contained in the received verification request reply signal, together with the corresponding local time information stored in the NVM 1300. The response validator 1340 compares the stored value of the result of the predefined operation with that contained in the received verification request reply signal; if the values are the same, the response validator 1340 determines that a ‘correct response’ has been received. If they do not match, the response validator 1340 determines that a ‘wrong response’ has been received. The response validator 1340 then sets the value of the result of the operation stored in the NVM 1335 to a predetermined value, in the present embodiment a value of zero, by overwriting the stored response. As discussed below, this feature has the advantage that it prevents a malicious replay attack from taking place.

The response validator 1340 also checks the length of time that has elapsed between the time at which the challenge generator 1320 stored the information associated with the index value in the NVM 1335 and the time at which the verification request reply signal was received by the response validator 1340. It does this by storing the value of local time at which the verification request reply signal was received by the response validator 1340 in the NVM 1335 together with the information already stored in the NVM 1335 and associated with the same index value and comparing the two values of stored time information. If the amount of time that has elapsed exceeds a predetermined ‘slow response’ threshold value, the response validator 1340 determines that the verification request reply signal corresponds to a ‘slow response’. Similarly, if the expected value of the predefined operation does not correspond to the value contained in the verification request reply signal, the response validator 1340 determines that a ‘wrong response’ has been received. If the number of slow responses or the number of wrong responses exceeds a predetermined threshold value within a predetermined time period, the response validator 1340 is configured to cause the vehicle 100 to stop moving and prevent further movement of the vehicle 100 in response to the receipt of signals from the remote device 1900.

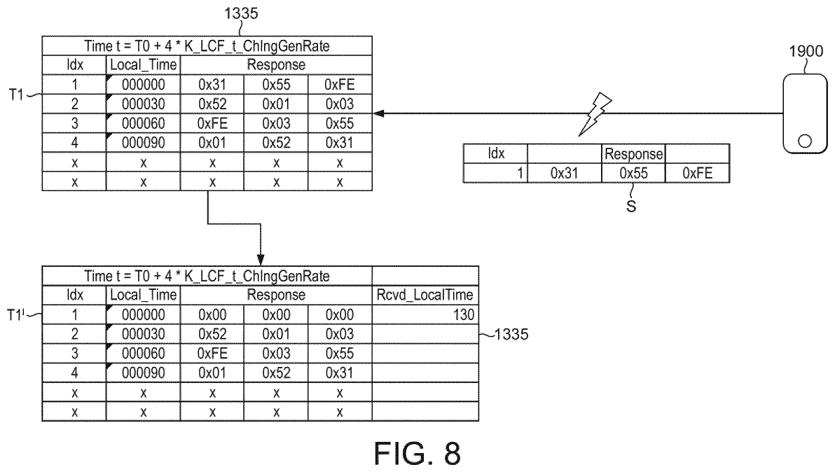

FIG. 8 illustrates the content of the NVM 1335 before (block T1) and after (block T1′) receipt of a first verification request reply signal S from the remote device 1900.

Immediately before receipt of the first verification request reply signal S, the NVM 1335 has data associated with four index values, Idx=1 to Idx=4, stored therein. As can be seen from block T1, the local time at which the first index value Idx=1 was stored was time ‘000000’, with successive index values stored at time intervals of ‘000030’, corresponding to ms time intervals. The verification request reply signal S is received by the response validator 1340 when the local time is ‘000130’. Accordingly, the response validator 1340 stores the time at which the signal S was received in the NVM 1335 and associates the stored time value with the index value contained in the signal S, i.e. with the index value Idx=1, as illustrated in block T1′ of FIG. 8. The response validator 1340 then compares the value of operation result with the value received in the verification request reply signal S to determine whether they match; in the present example they do match, and so the response validator 1340 sets the stored value of operation result to zero, as also illustrated in block T1′.

It is to be understood that according to the present embodiment the NFS 1300 only starts to check for failure in respect of communications based on time elapsed once the first reply has been received. This feature reduces a computational burden placed on the NFS 1300 by allowing it to accommodate communication time delays associated with the system in this way. Furthermore, this feature also mitigates the problem that the NFS 1300 determines that a ‘time out’ failure has occurred whilst communication is being established initially with the remote device 1900.

Accordingly, once the first reply is received, the NFS 1300 expects consecutive responses to arrive periodically, in the present embodiment every 30 ms.

Operation of the NFS 1300 in respect of the receipt of verification request reply

signals will now be described in further detail.

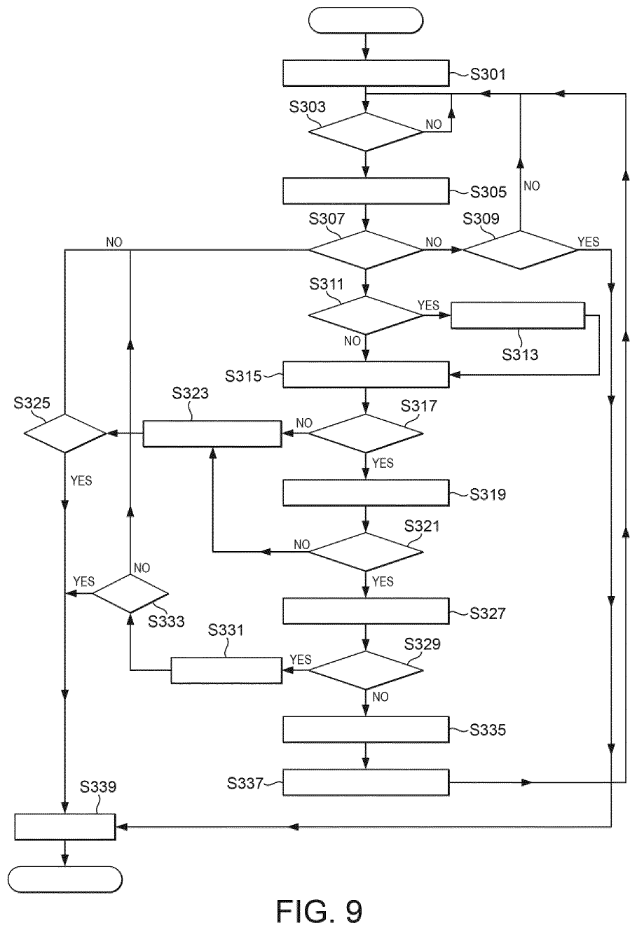

With reference to FIG. 9, at step S301 the response validator 1340 initializes an inactivity timer. The response validator 1340 may achieve this by setting an initial value of the inactivity timer to a predetermined value such as zero.

At step S303 the response validator 1340 checks whether a remote device 1900 has established a connection with the TCU 1100. If such a connection has been made the response validator 1340 continues at step S305 else it repeats step S303.

At step S305 the response validator 1340 starts the inactivity timer if it has not already been started.

At step S307 the response validator 1340 checks whether a new verification request reply signal has been received. If one has been received the response validator 1340 continues at step S311 else the response validator 1340 continues at step S309. At step S309 the response validator checks whether the time elapsed since the inactivity timer was started exceeds an inactivity threshold value. If the elapsed time does exceed the inactivity threshold, response validator 1340 continues at step S339 else the response validator 1340 continues at step S303.

At step S311 the response validator 1340 determines whether the response received is the first response since the response validator 1340 determined that a remote device was connected at step S303. If this is the case then the response validator 1340 continues at step S313 else the response validator 1340 continues at step S315.

At step S313 the response validator 1340 determines an overall latency value being a difference between the current local time information generated by the local timer 1330 and the time at which the first verification request signal was sent to the remote device 1900 by the challenge generator 1320 following the determination that a remote device 1900 was connected at step S109 of FIG. 6. The time at which the first verification request signal was sent to the remote device 1900 by the challenge generator 1320 is obtained by reference to the stored time information corresponding to the first index value (Idx=1). It is to be understood that this feature allows the NFS 1300 to automatically estimate the overall latency of signal transmission from the NFS 1300 (acting as challenger) to the remote device 1900 (acting as responder) and back to the NFS 1300 (as challenger), and eliminates a requirement for manual tuning. This measurement in respect of latency can be later used to detect abnormal responses in some embodiments, such as responses that took an unacceptably long time to be received by the NFS 1300.

At step S315 the response validator 1340 extracts from the newly received verification request reply signal the index value Idx and records the current value of local time information generated by the local timer function 1330. At step S317 the response validator 1340 determines whether an entry exists in the NVM 1335 corresponding to the value of index Idx received, i.e. an entry with the same index value. If a corresponding entry does exist, the response validator 1340 continues at step S319 else the response validator 1340 continues at step S323.

At step S323 the response validator 1340 increments a wrong response counter value and continues at step S325. It is to be understood that the checking by the response validator for a corresponding entry with the same index value in the NVM 1335 and incrementing the wrong response counter if such an entry is not found enables the system to prevent a ‘brute force’ attack where a third party injects signals with all possible combinations of values of parameters, or randomly generated combinations of values of parameters. This feature also detects cases where the index value is wrongly transmitted back to the challenger by the responder (in the present embodiment, back to the NFS 1300 by the remote device 1900), due for example to errors associated with hardware or software.

At step S325 the response validator 1340 checks whether the wrong response counter value exceeds a wrong response counter threshold value; if the wrong response counter value does exceed the wrong response counter threshold value then the response validator 1340 continues at step S339 else the response validator 1340 continues at step S307. It is to be understood that the wrong response counter threshold value may be set to any desired value, for example to a value dependent on a given application use case, taking into account the communications protocols employed. The value may for example be 2, 3, 4, 5, 10 or any other suitable value.

At step S339 the response validator 1340 interrupts or cancels control of the vehicle 1000 by the remote device 1900 by means of the RPA app, that is the NFS 1300 no longer permits the remote device 1900 to control vehicle motion. In the present embodiment, the NFS 1300 causes a braking system of the vehicle 1000 to stop the vehicle immediately.

As noted above, if at step S317 the response validator 1340 determines that an entry exists in the NVM 1335 corresponding to the value of index Idx received, the response validator 1340 continues at step S319.

At step S319 the response validator 1340 retrieves from the NVM 1335 the value of operation result information and local time information associated with the value of index corresponding to that of the received verification request reply signal.

At step S321 the response validator 1340 determines whether the value of operation result contained in the verification request reply signal is the same as the corresponding operation result information retrieved from the NVM 1335. If it is not the same, the response validator 1340 continues at step S323 else the response validator 1340 continues at step S327.

At step S327 the response validator 1340 calculates a signal delay value being a difference between the local time information generated by the local timer 1330 when the verification request reply signal was received and the time at which the challenge generator 1320 stored the corresponding operation result information in the NVM 1335. The signal delay value provides an indication of the time that elapsed between the NFS 1300 transmitting the verification request signal and the NFS 1300 receiving the verification request reply signal.

At step S329 the response validator 1340 determines whether the signal delay value exceeds a predetermined signal delay value threshold value. If the signal delay value does exceed the threshold value, the response validator 1340 continues at step S331, else the response validator 1340 continues at step S335. In the present embodiment the signal delay value threshold value is 30 ms although other values may be useful in some embodiments. It is to be understood that, in the present embodiment, the signal delay threshold value is set to a value that does not exceed the period between transmissions by the NFS 1300 to the remote device 1900 of verification request signals. As discussed above, in some embodiments the period between transmissions by the NFS 1300 is 30 ms.

In some embodiments, the NFS 1300 may be configured to set the predetermined ‘slow response’ threshold value to a value that is dependent on the estimated overall latency value, such as a value that is equal to the estimated latency value multiplied by a predetermined factor. In some embodiments the latency value may be determined by the system to be around ms and the predetermined factor may be around 3 or any other suitable value. It is to be understood that the factor may be chosen such that an amount of time that elapses before vehicle movement is prevented does not exceed a desired maximum value such as 100 ms, 200 ms, 300 ms, 400 ms, 500 ms or any other desired maximum value. It is to be understood that the value of the factor may be selected taking into account additional vehicle system latencies such as latencies associated with a vehicle braking system.

It is to be understood that the system may be configured such that the predetermined slow response threshold value cannot be set to a value higher than a predetermined maximum allowable value. As noted above, in the present embodiment, the signal delay threshold value is set to a value that does not exceed the period between transmissions by the NFS 1300 to the remote device 1900 of verification request signals.

It is to be understood that, in some embodiments, the signal delay threshold value may be varied dynamically based at least in part on the overall latency value determined at step S313. In addition or instead, in some embodiments the signal delay threshold value may be calculated at least in part on the value of signal delay value calculated at step S327 for a predetermined number of past values, for example an average value over a predetermined number of past values, such as the past 5, 10, 15 or any suitable number of successive past values.

At step S331 the response validator 1340 increments a slow response counter and clears the stored operation result information from the NVM 1335 in respect of the index value associated with the received verification request reply signal. At step S333 the response validator 1340 determines whether the slow response counter exceeds a predetermined slow response counter threshold value. If the slow response counter does exceed the predetermined slow response counter threshold value, the response validator 1340 continues at step S339 (described above) else the method continues at step S307. It is to be understood that this feature helps to protect the system against a replay attack as described above, in which a correct response is received but from a third party (fraudulent) source. It also protects the system against errors in which the value of index Idx is corrupted by the remote device 1900 or in the course of transmission between the remote device 1900 and NFS 1300, but where the response received is also valid. The predetermined slow response counter threshold value may be set to any suitable value such as 3, 4, 5, 10, 15, 20 or any other suitable value.

It is to be understood that if the estimated overall latency value is 10 ms and the predetermined factor is 3 (and therefore the slow response threshold value will be 30 ms) and the predetermined slow response counter threshold value is 3, then if the system becomes systematically slow and response counter a response takes more than 30 ms to be received on three successive occasions, the NFS 1300 will execute step S339 and vehicle movement will be prevented.

At step S335 the response validator 1340 clears the stored operation result information from the NVM 1335 in respect of the index value associated with the received verification request reply signal.

At step S337 the response validator 1340 continues operation by proceeding to step S303.

FIG. 10 illustrates a correspondence between the verification request signal and the verification request reply signal in the method of the embodiment of FIGS. 1 to 9. At step S401 of FIG. 10, the challenge generator 1320 executes a function Gen_Challenge( ) in which it receives three random numbers from the random number generator 1325, which form the arguments Chlng_Part1, Chlng_Part2, Chlng_Part 3, referred to above as Part 1, Part 2, and Part 3, respectively, for the predefined operation. At step S403 the challenge generator associates the arguments (argument information) with an index value Idx for transmission to the remote device 1900 together with a local time value (not indicated in FIG. 10).

At step S405, the challenge generator 1320 performs the operation described above using the generated arguments (argument information) using the function Gen_Response( ). At step S407 the challenge generator 1320 stores the result of the operation, ‘Response’, in the NVM 1335 after checking that the result meets the requirement for being a valid result as described above.

In some embodiments, the NFS 1300 is configured to prevent motion of the vehicle 1000 in response to a motion control signal received from the remote device 1900 in dependence on whether the order in which successive verification request reply signals are received corresponds to the order in which successive verification request signals were transmitted. This may be performed by determining whether the index value Idx associated with a received verification request reply signal corresponds to the expected succeeding index value to the index value Idx of the verification request reply signal received immediately previous to the most recently received verification request reply signal. If it does note, then the NFS 1300 may increment an ‘out of sequence’ counter. If the counter is incremented by more than a predetermined number within a predetermined time period the NFS 1300 may prevent motion of the vehicle 1000 in response to a motion control signal received from the remote device 1900. That is, the NFS 1300 may be configured to prevent motion of the vehicle 1000 in response to a motion control signal received from the remote device 1900 in dependence on a number of times within a given time period the order in which successive verification request reply signals are received does not correspond to the order in which successive verification request signals were transmitted.

It is to be understood that the present embodiment is able to detect a number of possible errors in respect of communication between the user and the NFS 1300. If hardware associated with the remote device 1900 fails or the wi-fi link between the remote device 1900 and the vehicle 1000 fails, a verification request reply signal will not be received by the NFS 1300 in response to transmission of a verification request signal by the NFS 1300. Furthermore, if corruption of the verification request signal or verification request reply signal occurs, the value of operation result performed on the argument information transmitted by the NFS 1300 will not match the corresponding value stored in the NVM 1335.

Embodiments of the present invention may also distinguish between user inactivity and a stuck communications failure. That is, because the NFS 1300 repeatedly requires the remote device 1900 to provide a response, by repeatedly transmitting the verification request signal, the NFS 1300 may determine that a stuck communications failure has not occurred even if a user is idle.

Furthermore, by requiring the remote device 1900 to perform an operation using a fresh argument information each time the verification request signal is received, the result of which cannot be predicted in advance of receipt of each verification request signal and the argument information it provides, the NFS 1300 may have increased confidence that the remote device 1900 is operating correctly.

The feature that the response validator 1340 logs slow responses as well as wrong responses enables the response validator 1340 to detect when a state of communication between the user and NFS 1300 may be unsuitable for continued remote vehicle operation by means of the remote device 1900, and terminate remote vehicle operation. It is to be understood that this feature enables the system to respond to a user request to stop the vehicle 1000 within a given time limit even if an unexpected communications delay or failure takes place. It is to be understood that a way of continuing operation of the system in the presence of substantial time delays might be to increase the time period between transmission of successive verification request signals, for example from a value of 30 ms to a value of 60 ms. However, a period of such length might prevent the NFS 1300 from causing the vehicle 1000 to stop sufficiently quickly in the event that a user requests the vehicle 1000 to stop, using the remote device 1900, and an excessive delay occurs between transmission of the verification request signal by the NFS 1300 and receipt of the corresponding verification request reply signal by the NFS 1300.

It is to be understood that, in the present embodiment, the NFS 1300 is configured only to generate and transmit the verification request signal to the remote device 1900 if the remote device 1900 is connected to the TCU 1100. If the connection becomes severed, for example if the remote device 1900 moves out of range or the wi-fi function of the remote device 1900 is switched off, the NFS 1300 terminates the sending of verification request signals.

In some embodiments of the present invention, the NFS 1300 is configured to communicate with remote devices provided at fixed locations and which provide location information to the NFS 1300 in order to assist the NFS 1300 in causing the vehicle 1000 to travel to a desired location by providing guidance information. In an embodiment, smart pillars 2900 are provided at spaced apart locations at a side of a desired path of travel of a vehicle as illustrated schematically in FIG. 12. Each pillar 2900 is configured to sense a location of the vehicle 1000 relative to the pillar 2900 and provide relative location information to the NFS 1300, enabling the NFS 1300 to guide a path of the vehicle past the pillar 2900 without colliding with the pillar 2900. In some embodiments the NFS 1300 may be configured to guide the vehicle 1000 along a trajectory that causes the vehicle 1000 to pass a pillar 2900 at a desired distance from the pillar 2900. As illustrated in FIG. 12, a row of pillars 2900 may be provided along one side of a desired path of travel of a vehicle 1000. In some embodiments, smart pillars 2900 may be provided on both sides of a desired path of travel of a vehicle 1000. The NFS 1300 may be configured to communicate with the smart pillars 2900 using a similar methodology to that by which the NFS 1300 communicates with a remote device 1900. That is, using the challenge/response methodology described above with reference to FIGS. 1 to 11.

It is to be understood that some embodiments of the present invention have the advantage that they may be implemented substantially independently of the communication medium and protocol used. Some embodiments have the advantage that they provide end to end protection by employing CRC technology. Some embodiments have the advantage that they provide end to end protection by detecting errors such as one or more of sequence errors in respect of verification request reply signals received by the vehicle in response to verification request signals transmitted by the vehicle, computational errors made by the remote device based on a challenge received from the NFS acting as challenger, timing errors and communication errors. Some embodiments have the advantage that they may function computationally faster and require less resources compared to complex data structures such as linked list methodologies. Some embodiments have the advantage that they enable decoupling of the development environment of the vehicle acting as challenger and remote device ac ting as responder. This enhances the developer's flexibility by reducing the constraints associated with equipment or software provided by a particular manufacturer or software developer, also referred to as vendor tie-in. This is at least in part because embodiments may be provided that do not rely on the use of a particular programming language or of particular computing hardware. As described herein, some embodiments of the present invention do not require synchronisation of time clocks between the vehicle and remote device. This is at least in part because in some embodiments the vehicle control electronics (the NFS 1300 in the embodiments described above) use a local time stamp and do not require timing information to be provided by the remote device. It is to be understood that a number of the parameters described herein are configurable in that the values employed may be changed according to a particular intended application. For example, the number of different index values stored in memory before the index values are overwritten may be varied according to the intended application.

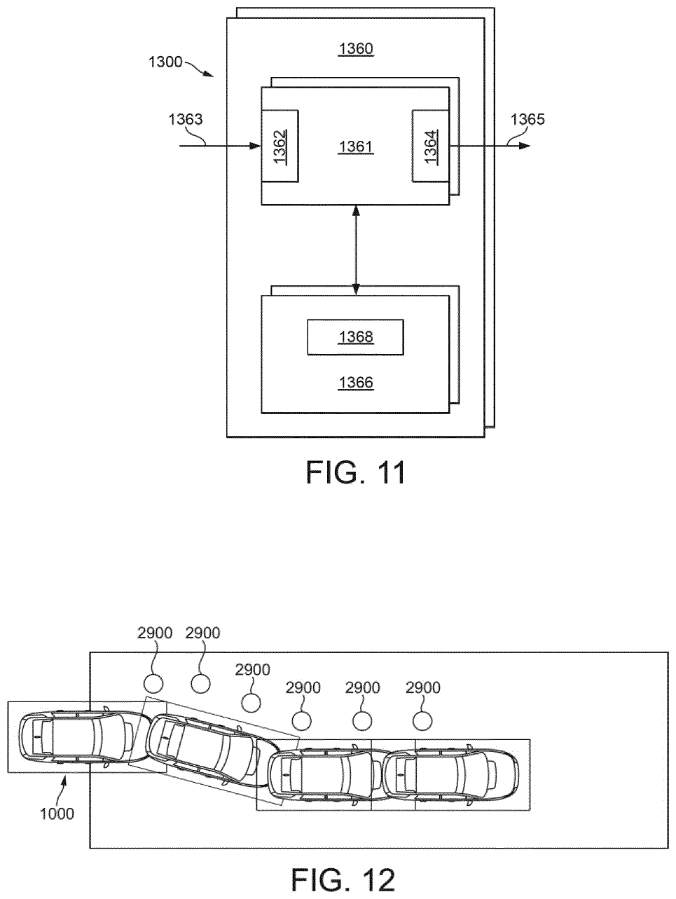

As illustrated in FIG. 11, it is to be understood that the NFS 1300 comprises at least one controller 1360 that comprises at least one electronic processor 1361 having one or more electrical input(s) 1362 for receiving one or more input signal(s)1363, and one or more electrical output(s) 1364 for outputting one or more output signal(s)) 1365. The or each controller 1360 further comprises at least one memory device 1366 electrically coupled to the at least one electronic processor 1361 and having instructions 1368 stored therein. The at least one electronic processor 1361 is configured to access the at least one memory device 1366 and execute the instructions 1368 stored therein so as to arranged to control, or provide input to a system to control, motion of a motor vehicle in response to a signal received from a remote device, wherein the at least one controller 1360 is arranged to perform a repeating verification cycle in which the at least one controller 1360 is configured to: transmit a verification request signal to the remote device 1900; listen for a verification request reply signal transmitted from the remote device 1900 in response to the verification request signal transmitted; compare, in the event that a verification request reply signal is received from the remote device 1900, the verification request reply signal to an expected verification request reply signal; and control, or provide input to a system to control motion of the vehicle 1000 in response to a motion control signal received from the remote device 1900 in dependence on receipt of a verification request reply signal corresponding to the expected verification request reply signal. The, or each, electronic processor 1361 may comprise any suitable electronic processor (e.g., a microprocessor, a microcontroller, an ASIC, 35 etc.) that is configured to execute electronic instructions. The, or each, electronic memory device 1366 may comprise any suitable memory device and may store a variety of data, information, threshold value(s), lookup tables or other data structures, and/or instructions therein or thereon. In an embodiment, the memory device 1366 has information and instructions for software, firmware, programs, algorithms, scripts, applications, etc. stored therein or thereon that may govern all or part of the methodology described herein. The processor, or each, electronic processor 1361 may access the memory device 1366 and execute and/or use that or those instructions and information to carry out or perform some or all of the functionality and methodology described herein.

The at least one memory device 1366 may comprise a computer-readable storage medium (e.g. a non-transitory or non-transient storage medium) that may comprise any mechanism for storing information in a form readable by a machine or electronic processors/computational/computing devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM or EEPROM); flash memory; or electrical or other types of medium for storing such information/instructions.

As noted above, it is to be understood that the or each controller 1360 can comprise
a control unit or computational device having one or more electronic processors 1361 (e.g., a microprocessor, a microcontroller, an application specific integrated circuit (ASIC), etc.), and may comprise a single control unit or computational device, or alternatively different functions of the or each controller 1360 may be embodied in, or hosted in, different control units or computational devices. As used herein, the term “controller,” “control unit,” or “computational device” (or “computing device”) will be understood to include a single controller, control unit, or computational device, and a plurality of controllers, control units, or computational devices collectively operating to provide the required control functionality. A set of instructions could be provided which, when executed, cause the controller 1360 to implement the control techniques described herein (including some or all of the functionality required for the method described herein). The set of instructions could be embedded in said one or more electronic processors of the controller 1360; or alternatively, the set of instructions could be provided as software to be executed in the controller 1360. A first controller or control unit may be implemented in software run on one or more processors. One or more other controllers or control units may be implemented in software run on one or more processors, optionally the same one or more processors as the first controller or control unit. Other arrangements are also useful.

Example controllers 1360 have been described comprising at least one electronic processor 1361 configured to execute electronic instructions stored within at least one memory device 1366, which when executed causes the electronic processor(s) 1361 to carry out the method as hereinbefore described. However, it is contemplated that the present invention is not limited to being implemented by way of programmable processing devices, and that at least some of, and in some embodiments all of, the functionality and/or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

1. A control system comprising one or more controllers, the control system arranged to control, or provide input to a system to control, motion of a motor vehicle in response to a motion control signal received from a remote device, wherein the control system is arranged to perform a repeating verification cycle in which the control system is configured to:
transmit a verification request signal to the remote device;
listen for a verification request reply signal transmitted from the remote device in response to the verification request signal transmitted;
compare, in the event that a verification request reply signal is received from the remote device, information comprised by the verification request reply signal with expected verification request reply information; and
control, or provide input to a system to control motion of the motor vehicle in response to a motion control signal received from the remote device based on the comparison.

2. The control system according to claim 1, wherein successive verification request signals transmitted by the control system each comprise information that includes argument information generated by the system, being information indicative of one or more arguments to be used with an operation, the system being configured to determine expected operation result information being information indicative of a result of a predefined operation using the argument information, the system being further configured to determine whether information comprised by the verification request reply signal received from the remote device includes operation result information corresponding to an expected result determined by the control system, wherein the system is configured to control, or provide input to a system to control, motion of the motor vehicle in response to a motion control signal received from the remote device based on a correspondence between the received operation result information and expected operation result information.

3. The control system according to claim 2, wherein the system is configured to store the expected operation result information together with the argument information and identifier information associated with the argument information and operation result information in a memory associated with the control system,
the system being configured to include, in the verification request signal, the identifier information associated with the argument information comprised by the verification request signal,
wherein the system being configured to determine whether information comprised by the verification request reply signal received from the remote device includes operation result information corresponding to the expected result determined by the control system comprises the system being configured to compare received result information and stored expected result information having common identifier information.

4. The control system according to claim 3, wherein once a verification request reply signal has been received having identifier information therein and the system has compared received result information and stored expected result information associated with that identifier information, the system is configured not to compare further received expected result information associated with that identifier information until fresh expected result information has been stored with the same identifier information.

5. The control system according to claim 1 configured to prevent motion of the motor vehicle in response to a motion control signal received from the remote device based on a number of times a verification request reply signal is received by the system within a prescribed time period that does not correspond to an expected verification request reply signal.

6. The control system according to claim 1 configured to prevent motion of the motor vehicle in response to a motion control signal received from the remote device based on whether an order in which successive verification request reply signals are received corresponds to an order in which corresponding successive verification request signals were transmitted.

7. The control system according to claim 6 configured to prevent motion of the motor vehicle in response to a motion control signal received from the remote device based on a number of times within a given time period the order in which successive verification request reply signals are received does not correspond to the order in which corresponding successive verification request signals were transmitted.

8. The control system according to claim 1 configured to implement a cyclic redundancy check in respect of data received.

9. A method of controlling motion of a vehicle by means of a control system, the method comprising controlling, or providing input to a system to control, motion of a motor vehicle in response to a motion control signal received from a remote device, the method comprising performing a repeating verification cycle, the method comprising:
transmitting a verification request signal to the remote device;
listening for a verification request reply signal transmitted from the remote device in response to the verification request signal transmitted;
comparing, in the event that a verification request reply signal is received from the remote device, information comprised by the verification request reply signal with expected verification request reply information; and
controlling, or providing input to a system to control motion of the vehicle in response to a motion control signal received from the remote device based on the comparison.

10. The method according to claim 9 comprising preventing vehicle movement responsive to a motion control signal received from the remote device based on receipt of an expected verification request reply signal.

11. A remote device configured to communicate with a control system arranged to control, or provide input to a system to control, motion of a motor vehicle in response to a motion control signal received from the remote device, wherein the remote device is configured to: listen for a verification request signal transmitted by the control system; and in response to receipt of a verification request signal transmitted by the control system, transmit a verification request reply signal to the control system.

12. The remote device according to claim 11 configured, in response to receipt of a verification request signal, to perform a predefined operation using argument information contained in the verification request signal, the remote device being configured to transmit the verification request reply signal in response to performing the predefined operation, the verification request reply signal comprising information indicative of a result of the predefined operation together with identifier information contained in the verification request signal.

13. A method of controlling motion of a vehicle having a control system, the method comprising, by means of a remote device, communicating with a control system arranged to control, or provide input to a system to control, motion of a motor vehicle in response to a motion control signal received from the remote device, the method comprising: listening for a verification request signal transmitted by the control system to the remote device; and in response to receipt of a verification request signal transmitted by the control system, transmitting a verification request reply signal to the control system.

14. The method according to claim 13 comprising, at the remote device, in response to receipt of a verification request signal by the remote device, performing a predefined operation using argument information contained in the verification request signal, the method comprising transmitting the verification request reply signal from the remote device to the control system in response to performing the predefined operation, the verification request reply signal comprising information indicative of a result of the predefined operation and identifier information contained in the verification request signal.

15. A non-transitory, computer-readable storage medium storing instructions thereon that, when executed by one or more electronic processors, causes the one or more electronic processors to carry out the method of claim 9.

16. A non-transitory, computer-readable storage medium storing instructions thereon that, when executed by one or more electronic processors, causes the one or more electronic processors to carry out the method of claim 13.

17. The control system according to claim 4, wherein the system is configured wherein once a verification request reply signal has been received having identifier information therein and the system has compared received result information and corresponding stored expected result information associated with that identifier information, the system is configured to delete the stored expected result information and corresponding identifier information from memory.
